(19) United States
(12) Patent Application Publication
(10) Pub. No.: US 2025/0319773 A1
(43) Pub. Date: Oct. 16, 2025

(54) VEHICLE DISPLAY DEVICE

(71) Applicant: TOYOTA JIDOSHA KABUSHIKI KAISHA, Toyota-shi (JP)

(72) Inventors: Shinsuke OMORI, Toyota-shi (JP); Masakatsu YAMADA, Yokohama-shi (JP)

(73) Assignee: TOYOTA JIDOSHA KABUSHIKI KAISHA, Toyota-shi (JP)

(21) Appl. No.: 19/073,166

(22) Filed: Mar. 7, 2025

(30) Foreign Application Priority Data
Apr. 12, 2024 (JP) 2024-064921

(51) Int. Cl. B60K 35/50; B60K 35/22

(52) U.S. Cl. CPC B60K 35/50; B60K 35/22; B60K 2360/771; B60K 2360/816

(57) ABSTRACT

A vehicle display device includes: a display provided with a display face; and an arm portion having one end portion side rotatably supported relative to a roof portion of a vehicle interior and having the display rotatably supported at another end portion side.

### CROSS-REFERENCE TO RELATED APPLICATION

This application is based on and claims priority under 35 USC 119 from Japanese Patent Application No. 2024-064921 filed on Apr. 12, 2024, the disclosure of which is incorporated by reference herein.

### BACKGROUND

### Technical Field

The present disclosure relates to a vehicle display device.

### Related Art

Japanese Patent Application Laid-Open (JP-A) No. 2008-100622 discloses a technique related to a vehicle display device. In this vehicle display device, a display is provided at the ceiling of a vehicle interior, and the display can assume a closed position in which the display face faces the ceiling face side, and an open position in which the display face faces the rear seat side.

However, in JP-A No. 2008-100622, the display is directly attached to the ceiling of the vehicle interior, and there are limitations on the position in which the display can be disposed, and on the angle of the display face of the display relative to a vehicle occupant. Namely, there is room for improvement from the perspective of securing the degree of freedom of the position in which the display is able to be disposed and of the angle of the display surface of the display relative to the occupant.

### SUMMARY

In consideration of the above circumstances, the present disclosure provides a vehicle display device for which a degree of freedom of the position in which the display can be disposed and of the angle of the display surface of the display relative to the occupant may be secured.

A vehicle display device according to a first aspect includes: a display provided with a display face; and an arm portion having one end portion side rotatably supported relative to a roof portion of a vehicle interior and having the display rotatably supported at another end portion side.

According to the vehicle display device according to the first aspect, a display and an arm portion are provided, and one end portion side of the arm portion is rotatably supported relative to the roof portion of the vehicle interior. Further, a display is rotatably supported at another end portion side of the arm portion.

As a result, in the present aspect, the position of the display in the vehicle interior may be changed by rotating the arm portion relative to the roof portion of the vehicle interior.

Further, in the present aspect, the orientation of the display face of the display may be changed by rotating the display relative to the arm portion.

A vehicle display device according to a second aspect of the present disclosure is the vehicle display device of the first aspect, in which the display and the arm portion are configured to assume a storage position disposed along the roof portion, and in the storage position, the display face faces a vehicle lower side.

According to the vehicle display device according to the second aspect, the display and the arm portion may assume a storage position in which they are disposed along the roof portion. Further, in this state, the display face of the display faces the vehicle lower side.

As a result, in the present aspect, the occupant may view the display face of the display in a state in which a distance between the occupant and the display in the vehicle interior is secured.

A vehicle display device according to a third aspect is the vehicle display device of the first aspect or the second aspect, further including: a first drive unit that rotates the arm portion relative to the roof portion; a second drive unit that drives the display relative to the arm portion; and a controller that is configured to controls the first drive unit and the second drive unit, wherein the controller is configured to controls the first drive unit and the second drive unit such that when the first drive unit is driven such that the other end portion side of the arm portion moves apart from the roof portion, the second drive unit is driven such that an area of the display face, as viewed from a direction orthogonal to a rotation axis of the display and along a horizontal direction, becomes larger than the area of the display face before movement of the arm portion.

According to the vehicle display device according to the third aspect, the display device includes a first drive unit that rotates the arm portion relative to the roof portion, and a second drive unit that drives the display relative to the arm portion, and these devices are controlled by a controller.

In the present aspect, the controller controls the first drive unit and the second drive unit such that when the first drive unit is driven such that the other end portion side of the arm portion moves apart from the roof portion, the second drive unit is driven such that the area of the display face of the display, as viewed from a direction orthogonal to the rotation axis of the display and along the horizontal direction, is increased.

As a result, in the present aspect, the angle of the display face of the display may be adjusted to an angle that is easily visible to an occupant in a state in which their upper body is upright, while suppressing interference between the display and the roof portion.

A vehicle display device according to a fourth aspect is the vehicle display device of the third aspect, in which the controller is configured to control the first drive unit such that an angle of the arm portion relative to the roof portion becomes a predetermined angle.

According to the vehicle display device according to the fourth aspect, the angle of the arm portion relative to the roof portion may be set to a predetermined angle by the first drive unit being controlled by the controller. As a result, in the present aspect, compared to a configuration in which the display is directly attached to the roof portion of the vehicle interior, the display may be disposed at a position closer to the occupant.

A vehicle display device according to a fifth aspect is the vehicle display device of any one of the second aspect to the fourth aspect, a roof rail garnish is provided relative to each of a pair of roof side rails configuring portions at vehicle width direction outer sides of the roof portion so as to cover the roof side rails from a side of the vehicle interior, a concave portion is provided in the roof rail garnish, and the arm portion is configured such that, in the storage position, a portion of the arm portion is housed in the concave portion as viewed from the vehicle vertical direction.

According to the vehicle display device according to the fifth aspect, a roof side rail configuring a vehicle width direction outer side portion of the roof portion is covered with a roof rail garnish from the vehicle interior side. Further, a concave portion is formed in the roof rail garnish, and this concave portion is configured to house a portion of the arm portion in the storage position as viewed from the vehicle vertical direction.

As a result, in the present exemplary embodiment, compared to a configuration in which the arm portion in the storage position is positioned at an inner side in the vehicle width direction of the roof rail garnish, the space in which a display may be disposed between roof rail garnishes may be increased.

As explained above, the vehicle display device according to the present disclosure may secure a degree of freedom of the position at which the display may be disposed, and of the angle of the display face of the display relative to the occupant.

### BRIEF DESCRIPTION OF THE DRAWINGS

FIG. 1 is a cross-section (a cross-section taken along line 1-1 in FIG. 2) schematically illustrating a configuration inside a vehicle interior of a vehicle provided with a vehicle display device according to the present exemplary embodiment.

FIG. 2 is a bottom view schematically illustrating a configuration around a roof portion of a vehicle interior in a vehicle provided with a vehicle display device according to the present exemplary embodiment.

FIG. 3 is a block diagram illustrating an exemplary hardware configuration of a vehicle display device according to the present exemplary embodiment.

### DETAILED DESCRIPTION

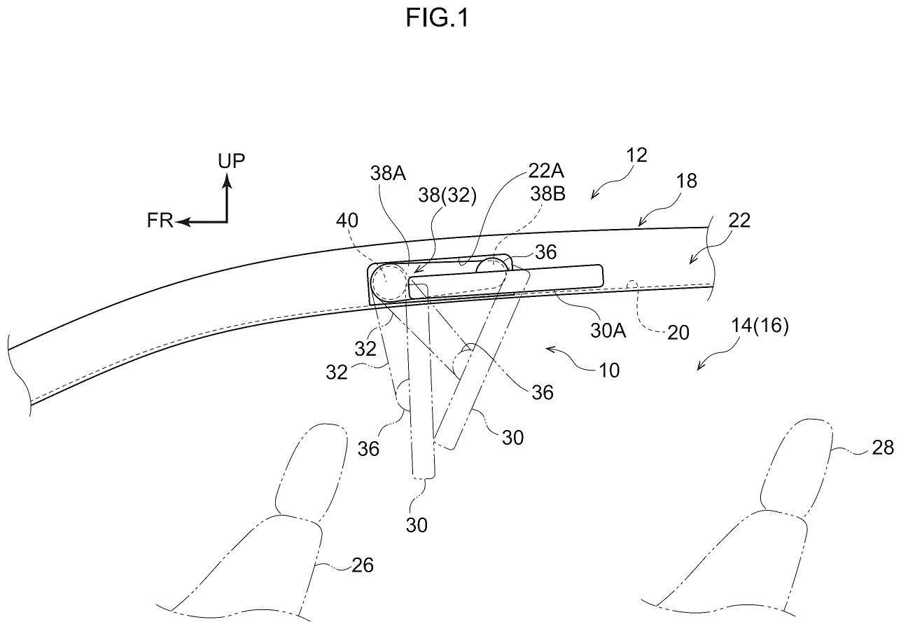

Explanation follows regarding exemplary embodiments of a vehicle display device according to the present disclosure, with reference to FIGS. 1 to 3. Note that the arrow FR illustrated in the respective drawings indicates the vehicle front side of a “vehicle 12” installed with a “vehicle display device 10” (hereafter, referred to as display device 10) according to the present exemplary embodiment, the arrow UP indicates the vehicle upper side of the vehicle 12, and the arrow LH indicates the vehicle width direction left side of the vehicle 12.

Explanation follows regarding a schematic configuration of the vehicle 12, with reference to FIG. 1. The vehicle 12 includes a vehicle body 16 configuring a main portion of a vehicle interior 14, and a vehicle upper side portion of the vehicle body 16 is configured by a roof portion 18. Note that a vehicle lower side portion of the vehicle body 16 is configured by a floor portion that is not illustrated in the drawings.

The roof portion 18 includes a pair of roof side rails 20 that extend in the vehicle front-rear direction and the vehicle width direction and are disposed at both vehicle width direction sides of the roof portion 18. The roof side rails 20 are each covered from the inside of the vehicle interior 14 by a roof rail garnish 22.

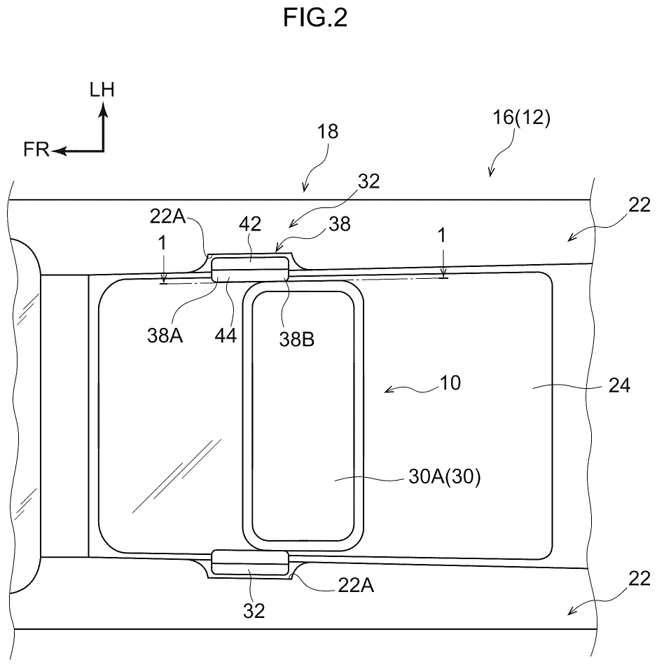

As illustrated in FIG. 2, a roof window 24 configured by a colorless and transparent inorganic glass plate having a constant thickness and having its length direction along the vehicle front-rear direction extends between the roof side rails 20; that is, the roof portion 18 is configured as a so-called panoramic roof.

In the vehicle interior 14 of the vehicle body 16 configured as described above, a front seat 26 is disposed at the vehicle front side, and a rear seat 28 is disposed at the vehicle rear side. Various appliances configuring the display device 10 are disposed at a vehicle rear side of the front seat 26 and a vehicle front side of the rear seat 28 in the roof portion 18.

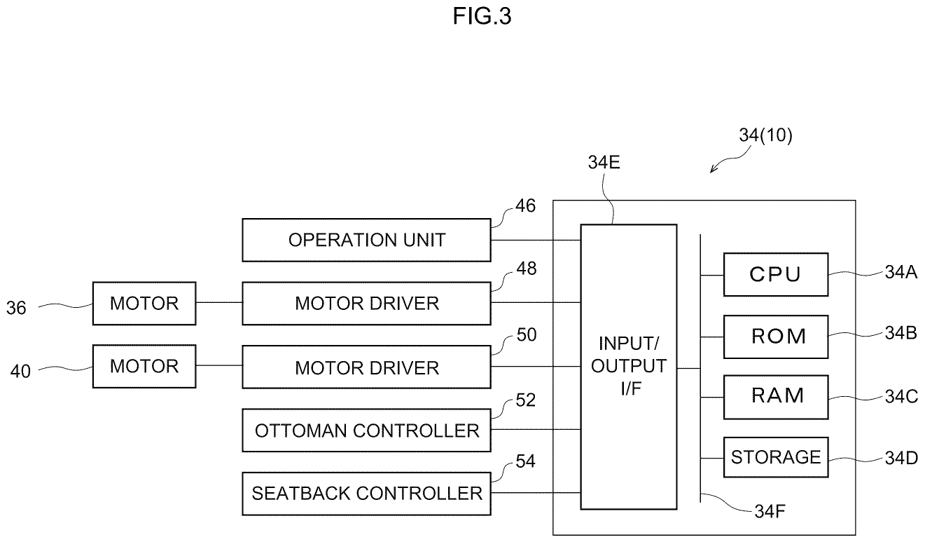

As also illustrated in FIG. 3, the display device 10 includes a display 30, a pair of arm portions 32 and a controller 34.

The display 30 has a rectangular shape with its length direction along the vehicle width direction in plan view, and is provided with a display face 30A that is capable of displaying various types of information to an occupant, not illustrated in the drawings, seated in the rear seat 28. The display 30 is electrically connected to a display controller, not illustrated in the drawings, through wiring, not illustrated in the drawings, and by being driven on the basis of signals output from the display controller, various images, messages, and the like may be displayed at the display surface 30A.

At both vehicle width direction sides of the display 30, a motor gear unit 36, as a second drive unit, is provided at a portion at a central part in the short-side direction at an opposite side from the display face 30A. The display 30 is supported by the roof side rail 20 via the arm portions 32 at both vehicle width direction sides thereof. Note that driving of the motor gear unit 36 is controlled by the controller 34, as described below.

More specifically, the arm portion 32 includes an arm body portion 38 configuring the main portion thereof, and a motor gear unit 40, as a first drive unit.

The arm body portion 38 is configured including an arm outer 42 configuring a vehicle width direction outer side portion thereof, and an arm inner 44 configuring a vehicle width direction inner side portion thereof, and its interior is hollow. The motor gear unit 40 is incorporated in one end portion 38A of the arm body portion 38, and the motor gear unit 40 is coupled to a bearing portion, not illustrated in the drawings, provided inside the roof side rail 20. Thus, the arm portion 32 is configured in a state in which the one end portion 38A side is supported rotatably about the vehicle width direction relative to the roof portion 18. Namely, the extension direction of the rotation shaft of the display 30 is the vehicle width direction.

A concave portion 22A that is recessed toward the vehicle width direction outer side and that is open at the vehicle lower side is formed at a position at which the arm portion 32 is attached in the roof rail garnish 22. Part of the arm portion 32 is housed in the concave portion 22A, as described later.

A bearing portion, not illustrated in the drawings, is incorporated in an other end portion 38B of the arm body portion 38, and a motor gear unit 36 provided at the display 30 is coupled to the bearing portion. Thus, the arm portion 32 is configured in a state in which the display 30 is supported rotatably around the vehicle width direction at the other end portion 38B side.

Explanation follows regarding the configuration of the controller 34, with reference to FIG. 3. The controller 34 is configured including a CPU (central processing unit) 34A, a ROM (read only memory) 34B, a RAM (random access memory) 34C, a storage 34D, and an input/output I/F (interface) 34E. The CPU 34A, the ROM 34B, the RAM 34C, the storage 34D, and the input/output I/F 34E are connected so as to be capable of communicating with each other through a bus 34F.

The CPU 34A is a central processing unit, and is capable of controlling various appliances by executing various programs. Specifically, the CPU 34A reads out a program from the ROM 34B, and is capable of executing the program using the RAM 34C as a work space. By an execution program stored in the ROM 34B being read and executed by the CPU 34A, the controller 34 is capable of performing various functions, as described later. The controller 34 may be configured by a processor, and the CPU 34A is an example of the processor.

More specifically, various programs and various data relating to control and the like of the motor gear unit 36 and the motor gear unit 40 are stored in the ROM 34B. The RAM 34C is capable of temporarily storing programs or data as a work space.

The storage 34D is configured including an HDD (Hard Disk Drive) or an SSD (Solid State Drive), and various programs including an operating system and various data may be stored.

The input/output I/F 34E is an interface through which the controller 34 communicates with various appliances installed in the vehicle 12. The controller 34 is inter-communicatively connected to respective devices described later via the input/output I/F 34E.

Specifically, examples of appliances connected to the controller 34 include an operation unit 46 used in operation of the display device 10, a motor driver 48 that drives the motor gear unit 36, a motor driver 50 that drives the motor gear unit 40, an ottoman controller 52 that drives an ottoman drive unit, not illustrated in the drawings, provided at the rear seat 28, and a seatback controller 54 that drives a drive unit, not illustrated in the drawings, that rotates the seatback 28A of the rear seat 28.

The controller 34 controls the motor driver 48 and the motor driver 50 based on operation signals output from the operation unit 46 as a result of an occupant seated in the rear seat 28 operating the operation unit 46, and the display 30 and the arm portion 32 may be moved to the position desired by the occupant.

Specifically, when the occupant applies normal operation to the motor gear unit 40 with the operation unit 46 and the arm portion 32 rotates, the motor driver 48 and the motor driver 50 are controlled such that the display 30 rotates in conjunction with the arm portion 32.

More specifically, the display 30 and the arm portion 32 assume a storage position in which they are disposed along the roof portion 18 in a normal state (initial position). When this occurs, the display face 30A of the display 30 is in a state facing the vehicle lower side. Further, in this state, as illustrated in FIG. 2, a main portion of the arm portion 32 is in a state housed in the concave portion 22A formed in the roof rail garnish 22, as viewed from the vehicle vertical direction.

When the arm portion 32 is rotated such that the other end portion 38B of the arm portion 32 moves apart from the roof portion 18, from the state in which the display 30 and the arm portion 32 are in the storage position, the controller 34 controls the motor gear unit 36 and the motor gear unit 40 via the motor driver 48 and the motor driver 50 so as to increase the area of the display face 30A of the display 30 as viewed from the rear seat 28 side in the vehicle front-rear direction.

Note that in the following, a state in which the display 30 and the arm portions 32 are disposed along the vehicle vertical direction is referred to as a full deployment position of the display 30 and the arm portions 32. Further, a state in which the arm portions 32 are positioned between the storage position and the full deployment position is referred to as a half deployment position of the display 30 and the arm portions 32.

In the present exemplary embodiment, when the display 30 and the arm portions 32 shift from the full deployment position or the half deployment position to the storage position in normal operation by the occupant, when the arm portion 32 rotates such that the other end portion 38B of the arm portion 32 approaches the roof portion 18, the controller controls the motor gear unit 36 and the motor gear unit 40 so as to reduce the area of the display face 30A of the display 30 as viewed from the rear seat 28 side in the vehicle front-rear direction.

In the present exemplary embodiment, the display 30 and the arm portion 32 may be rotated independently of each other by the occupant performing an adjustment operation with the operation unit 46.

In addition, in the present exemplary embodiment, the controller 34 controls the ottoman controller 52 and the seatback controller 54 based on operation of the operation unit 46 by the occupant, whereby it is possible to drive the ottoman and the seatback 28A into the state desired by the occupant.

In the present exemplary embodiment, the display 30 and the arm portion 32 are rotated into predetermined states in conjunction with the driving of the ottoman and the seatback 28A.

### Mechanism and Effect of Present Exemplary Embodiment

Explanation follows regarding the mechanism and advantageous effects of the present exemplary embodiment.

As illustrated in FIGS. 1 and 2, the present exemplary embodiment includes the display 30 and the arm portion 32, and the one end portion 38A side of the arm portion 32 is rotatably supported relative to the roof portion 18 of the vehicle interior 14. Further, the display 30 is rotatably supported at the other end portion 38B side of the arm portion 32.

Thus, in the present exemplary embodiment, the position of the display 30 inside the vehicle interior 14 may be changed by rotation of the arm portion 32 relative to the roof portion 18 of the vehicle interior 14.

In the present exemplary embodiment, the orientation of the display face 30A of the display 30 may be changed by rotating the display 30 relative to the arm portion 32.

In the present exemplary embodiment, the display 30 and the arm portions 32 may assume a storage position in which they are disposed along the roof portion 18. In this state, the display face 30A of the display 30 faces the vehicle lower side.

Thus, in the present exemplary embodiment, the occupant may see the display face 30A of the display 30 in a state in which a distance between the occupant and the display 30 in the vehicle interior 14 is secured.

In the present exemplary embodiment, a motor gear unit 40 that rotates the arm portion 32 relative to the roof portion 18, and a motor gear unit 36 that drives the display 30 relative to the arm portion are provided, and these are controlled by the controller 34.

In the present exemplary embodiment, when the motor gear unit 40 is driven such that the other end portion 38B side of the arm portion 32 moves apart from the roof portion 18, the controller 34 controls the motor gear unit 36 and the motor gear unit 40 such that the motor gear unit 36 is driven such that the area of the display face 30A of the display 30 viewed from a direction perpendicular to the rotation axis of the display 30 and along the horizontal direction is increased.

Thus, in the present exemplary embodiment, while suppressing interference between the display 30 and the roof portion 18, the angle of the display face 30A of the display 30 may be adjusted to an angle that is easily visible to an occupant in a state in which their upper body is upright.

In the present exemplary embodiment, the motor gear unit 40 is controlled by the controller 34 such that the angle of the arm portion 32 relative to the roof portion 18 may be set to a predetermined angle. Thus, in the present exemplary embodiment, compared to a configuration in which the display 30 is directly attached to the roof portion 18 of the vehicle interior 14, the display 30 may be disposed at a position closer to the occupant.

In addition, in the present exemplary embodiment, the roof side rail 20 configuring the vehicle width direction outer side portion of the roof portion 18 is covered with the roof rail garnish 22 from the inner side of the vehicle interior 14. Further, a concave portion 22A is formed in the roof rail garnish 22, and part of the arm portion 32 in the storage position is housed in this concave portion 22A as viewed from the vehicle vertical direction.

Thus, in the present exemplary embodiment, compared to a configuration in which the arm portion 32 in the storage position is positioned at a vehicle width direction inner side of the roof rail garnish 22, the space in which the display 30 may be disposed between the roof rail garnishes 22 may be increased.

As explained above, according to the display device 10 according to the present exemplary embodiment, a degree of freedom of the position in which the display 30 may be disposed and of the angle of the display face 30A of the display 30 relative to the occupant may be secured.

Note that in the above exemplary embodiment, the display face 30A is provided at the vehicle lower side of the display 30 in the stored state of the display 30; however, the display face 30A may be provided also on a face of the display 30 that becomes the vehicle upper side in a stored state of the display 30.

Such a configuration enables a message or the like displayed at the display face 30A at the vehicle upper side to be visually perceived from the vehicle exterior through the roof window 24 in the stored state of the display 30. In addition, by causing the display face 30A at the vehicle upper side to emit light in the stored state of the display 30, the display 30 may be used as illumination with respect to the vehicle exterior. In addition, in a state in which the display 30 and the arm portions 32 are in the full deployment position or half deployment position, various images, messages, and the like may be displayed on the front seat 26 side using the display face 30A at the vehicle front side.

What is claimed is:

1. A vehicle display device, comprising:
a display provided with a display face; and
an arm portion having one end portion side rotatably supported relative to a roof portion of a vehicle interior and having the display rotatably supported at another end portion side.

2. The vehicle display device of claim 1, wherein:
the display and the arm portion are configured to assume a storage position disposed along the roof portion, and i
n the storage position, the display face faces a vehicle lower side.

3. The vehicle display device of claim 1, further comprising:
a first drive unit that rotates the arm portion relative to the roof portion;
a second drive unit that drives the display relative to the arm portion; and
a controller that is configured to controls the first drive unit and the second drive unit,
wherein the controller is configured to control the first drive unit and the second drive unit such that when the first drive unit is driven such that the other end portion side of the arm portion moves apart from the roof portion, the second drive unit is driven such that an area of the display face, as viewed from a direction orthogonal to a rotation axis of the display and along a horizontal direction, becomes larger than the area of the display face before movement of the arm portion.

4. The vehicle display device of claim 3, wherein the controller is configured to control the first drive unit such that an angle of the arm portion relative to the roof portion becomes a predetermined angle.

5. The vehicle display device of claim 2, wherein:
a roof rail garnish is provided relative to each of a pair of roof side rails configuring portions at vehicle width direction outer sides of the roof portion so as to cover the roof side rails from a side of the vehicle interior,
a concave portion is provided in the roof rail garnish, and
the arm portion is configured such that, in the storage position, a portion of the arm portion is housed in the concave portion as viewed from the vehicle vertical direction.
